(19) United States
(12) Patent Application Publication
(10) Pub. No.: US 2022/0234585 A1
(43) Pub. Date: Jul. 28, 2022

(54) SYSTEM AND METHOD FOR RECHARGING BATTERIES OF ELECTRIC AND HYBRID VEHICLES

(71) Applicant: Carlo ROSMINO, Piobesi Torinese (Torino) (IT)

(72) Inventor: Carlo ROSMINO, Piobesi Torinese (Torino) (IT)

(21) Appl. No.: 17/611,070

(22) PCT Filed: May 14, 2020
(86) PCT No.: PCT/IB2020/054576

§ 371 Date: Nov. 12, 2021

(30) Foreign Application Priority Data
May 15, 2019 (IT) 102019000006848

(51) Int. Cl. B60W 30/18; H02K 7/00; B60L 7/24; H02K 7/18; B60W 10/08

(52) U.S. Cl. CPC B60W 30/18127; H02K 7/006; B60W 10/08; H02K 7/1853; B60L 7/24

(57) ABSTRACT

A system for recharging batteries of electric and hybrid vehicles by recovering and converting kinetic energy produced by rotational movement of wheels into electric current is provided. The system includes an electric current generator having a rotor integrated in an inner surface of a tire-carrying rim and a circular-shaped stator anchored to a fixed part of a wheel-carrying hub in a volume between a brake and the inner surface of the tire-carrying rim.

### TECHNICAL FIELD

The present invention falls within the context of the development of sustainable mobility, with reference to the technical field of electric and hybrid vehicles, and in particular to recharging the power batteries thereof and keeping them charged.

### PRIOR ART

It is known that the progressive reduction in the emissions of pollutants produced by the use of traditional vehicles having a combustion engine is crucial not only to the development and future use of the vehicles, but also to the mobility itself—understood as the free circulation of people and things. In this direction, standards that limit the transit of vehicles in urban and suburban areas are being increasingly adopted by authorities in towns and cities in Italy and abroad, and are being increasingly expanded and extended over time. These types of measures, which are often adopted as emergency measures when levels of air quality criticality are reached, guarantee only limited and temporary benefits, which do not to structurally contribute to achieving the object of fewer emissions. The use of sharing services, such as car pooling and car sharing, is also of little impact, because, while proposing a more responsible use of the vehicles (attempting to in fact limit the number of vehicles in circulation), may inevitably only reach a reduced number of users also.

The production and technological innovation sectors are without a doubt the most active and directly affected by the development of high-efficiency solutions. As combustion engines that reduce both the consumption and the emission of pollutants have been developed and used, the use of electric motors in combination with combustion engines in hybrid vehicles or as a single engine in electric vehicles is now widespread.

Until now, these electrically powered and hybrid vehicles, which are completely or partly fuel-free, appear to be the most tangible possibility for reaching the objective of sustainable mobility.

However, despite the growing offer of new models proposed by manufacturers and the achievement of large market shares, the limitations that still prevent a large-scale distribution of this type of vehicle must not be forgotten.

In fact, the reduced autonomy/runtime, which is closely associated with the capacity of the different types of batteries installed, affects the use of the vehicle during medium-long distances.

Furthermore, the times and possibilities to recharge the batteries outside the connection to the domestic power grid require long stops at charging points, which are still not distributed in a widespread manner. The installation of the charging stations itself entails a significant intervention on the infrastructure and, in particular in metropolitan areas, a further decrease of rest areas.

Therefore, the increase in the requirement for electric current, a very small percentage of which has been produced from renewable sources until now, would cancel out the ecological effect generated by the increased use of electric and hybrid vehicles.

Understandably, these limitations compromise the emergence of technologies and solutions for a more sustainable mobility.

### SUMMARY OF THE INVENTION

The object of the present invention is to offer a solution that fully expresses the non-polluting potential of electric motors for vehicle propulsion. The object of the present invention is also to offer a solution that is simple to implement, which thereby reduces the design and production costs, does not alter the current design ideas and techniques and may be integrated in the models already present on the market with minimal interventions.

These objects are achieved by a system and a method for recharging electric and hybrid vehicle batteries according to the present invention.

The vehicle is recharged while it is moving by converting the kinetic energy generated by the rotary movement of the wheels into electrical energy to the batteries. This is achieved without adding additional mechanical elements for transmitting the rotational movement to a new generator, for example a shaft or timing belt, which would involve friction and braking forces that compromise the efficiency of the electric motor and a further loss of power output necessary for moving the vehicle.

The solution proposed by the present invention is to identify the spaces already inside the wheel and the times that are useful for converting the kinetic energy into electric current. Since the rim is a connecting element between the tire and the vehicle, the interior of the rim becomes the rotor and the first fundamental element of the generator. Both rims made of steel or a commonly used alloy and rims made of steel or a specially designed and formed alloy have proven to be suitable for optimizing the accommodation of permanent magnets.

These permanent magnets are suitably positioned in the inner surface of the rim (along all or part of the circumference thereof), and may vary in terms of material type, number, size and shape, force of attraction and orientation on the basis of the dimensional characteristics of the rim, diameter, anchoring plane to the hub and offset.

The permanent magnets are suitably fixed inside of the rim by means of a polyurethane resin having a solid end state, which guarantees the immobility and integrity thereof when the wheel is rotating.

A stator, which constitutes the second fundamental element of the generator, is suitably arranged in a space between the inner surface of the rim (to which the permanent magnets are attached) and a brake-carrying plate that is connected to the fixed part of the vehicle.

As for the rotor, the size of the stator is also directly linked to the dimensional characteristics of the rim, leaving a spacing between the two elements that is suitable for ensuring a safe and regular rotation of the wheel.

The stator, which has a circular shape and is suitably made of a specific polyurethane resin having a solid end state, is anchored to the fixed part of the brake-carrying plate or to another support formed for this purpose. The type of fastening, suitably by means of prepared holes and accessories, may be integrated with both types of brake systems that are normally installed in the vehicles, disc and drum brake systems.

Enameled copper wire windings are provided inside the stator in an amount, size and orientation that is necessary for the production of the electric current. The current generated by the stator is suitably transmitted by means of wires to an electronic control device that manages the process of recharging batteries, thereby adjusting the voltage and the intensity of the flow of current.

The above-mentioned and other objects and advantages are achieved, according to one aspect of the invention, by a system and by a method having the features defined in the attached claims.

### BRIEF DESCRIPTION OF THE DRAWINGS

The functional and structural features of a few preferred embodiments of a system and a method according to the invention will now be described. Reference is made to the attached drawings, in which:

FIG. 1 is a schematic perspective view showing a rim 1A inside a tire 1C, in which permanent magnets 1B are arranged along the inner surface, according to one embodiment of the invention;

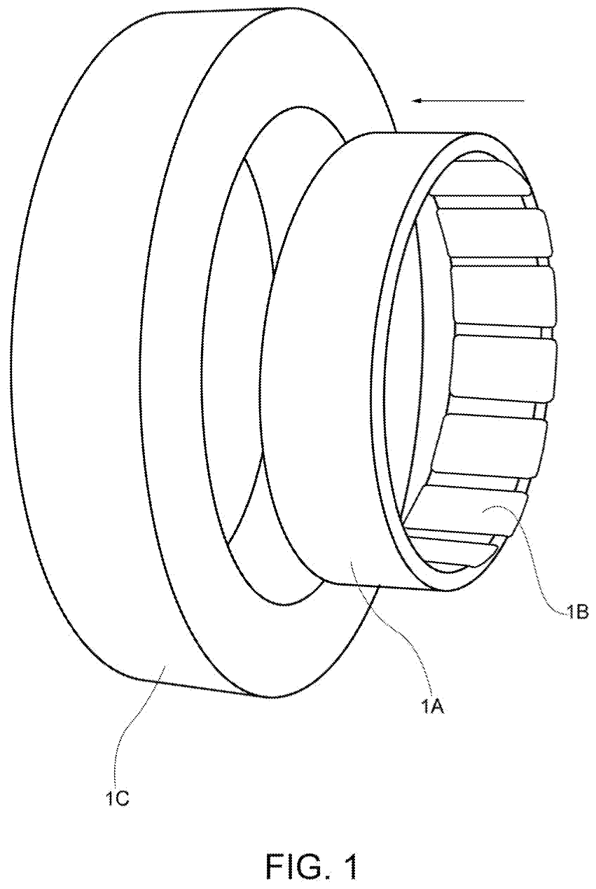

FIG. 2 shows a stator 2A showing some of the windings 2C contained therein in relief, a braking element 2B and a useful space 2D arranged between the rim and the stator 2A that allows the wheel to rotate;

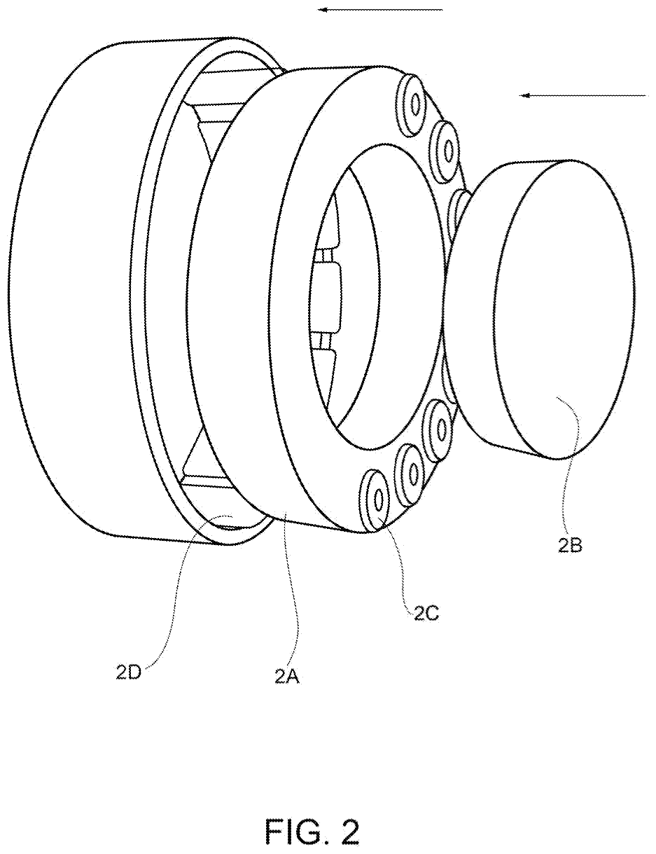

FIG. 3 shows the stator showing a wire exit point 3A for the transmission of an electrical signal towards a control device in relief, the braking element 3D contained in the internal volume thereof, and a brake-carrying plate 3C that is anchored to the fixed part of the vehicle by means of points 3B for fastening it to the stator; and

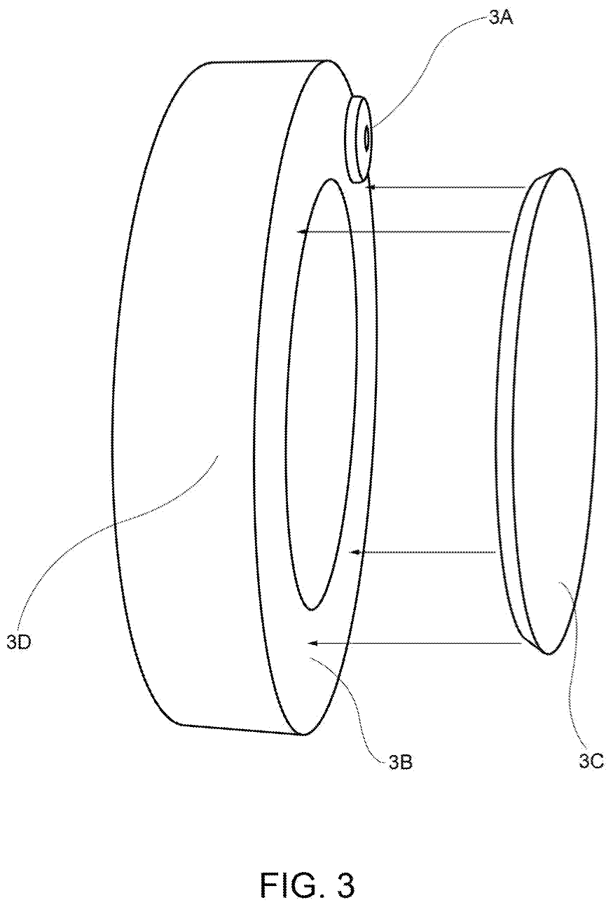

FIG. 4 is an overall lateral view of a wheel comprising a tire 4A, the rim containing the permanent magnets 4B, the stator 4C and the braking element 4D, according to one embodiment of the invention.

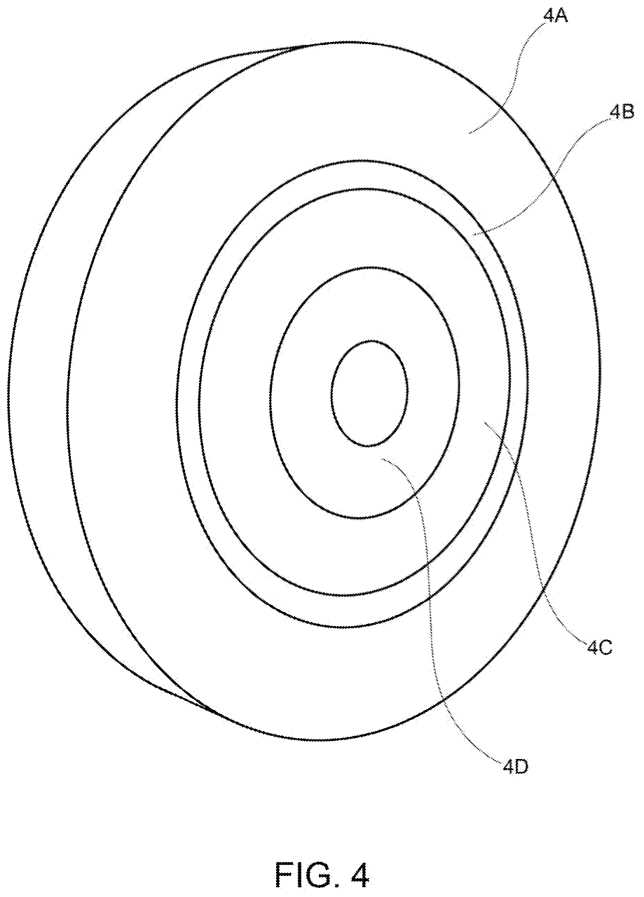

### DETAILED DESCRIPTION OF THE INVENTION

With reference to the drawings by way of example, a system for recharging electric and hybrid vehicle batteries according to the invention, for recovering and converting the kinetic energy produced by the rotational movement of the wheels into electric current comprises a tire-carrying rim 1A, adapted to support a tire 1C, 4A, and an electric current generator, which generator comprises a rotor that is integrated in the inner surface of said tire-carrying rim 1A, and a stator 2A, 4C that is rotationally fixed with respect to the tire-carrying rim 1A and it is adapted to be anchored to the fixed part of a wheel-carrying hub in the volume between a braking element 3D, 4D that is mechanically connected to said wheel-carrying hub and the inner surface of the tire-carrying rim 1A.

Electrical storage means (suitably, traditional batteries) are also provided, which are electrically connected to the generator and which electrical storage means are suppliable with power by means of the current produced by this generator.

The system also comprises electronic control means (suitably, an electronic control unit of the type known per se) that is electrically connected to the electrical storage means and are suppliable by means of the current produced by the electric current generator.

This electronic control device is designed to only allow the passage of a flow of current from said generator to the electrical storage means (that is, preventing the passage of a flow of current from the electrical storage means to said generator). In this way, the system according to the present invention carries out the sole function of recharging the batteries, thus not being suitable to operate as a driving machine that may impart a rotational movement on the associated wheel.

Conveniently, the electronic control device is configured to adjust the voltage and the intensity of said flow of current from said generator to the electrical storage means.

According to a preferred embodiment, the system comprises permanent magnets 1B, 4B that are fixed (suitably by means of a polyurethane resin) to the inner surface of the tire-carrying rim 1A.

Conveniently, the stator 2A, 4C is circular, is made of a polyurethane resin having a solid end state and contains enameled copper wire windings 2C.

According to one embodiment, the system also comprises a wheel-carrying hub, which rotatably supports the tire-carrying rim 1A, and a braking element 3D, 4D that is mechanically connected to the wheel-carrying hub and is adapted to impart a brake torque on the tire-carrying rim 1A.

The system described above, which may be installed in one or more wheels of a vehicle on the basis of the energy requirement thereof, produces electric current for recharging the batteries so as to increase the energy efficiency of the system. The production and consumption vary in accordance to the travelling conditions of the vehicle, thus increasing or decreasing progressively as the speed and the journey type changes. In addition to the management cost reduction, it is also possible to assume a substantial reduction in the final price of the vehicle, making it possible to limit the number of batteries required to ensure an appropriate traveling range. In prospect, in addition to new development solutions for future models that reconsider the volume and weight, equipping the vehicle with fewer batteries may offer more appropriate environmental sustainability at the end of their life cycle.

According to one aspect of the invention, a method is also provided for recharging electric and hybrid vehicle batteries, comprising the steps of providing a recharging system according to any one of the embodiments described above, providing a vehicle having at least one wheel to which this system is associated, and transmitting the electric current produced by the generator from the stator to the batteries by means of the electronic control device when the vehicle is travelling.

According to one embodiment, such final step is carried out by adjusting the voltage and the intensity of said flow of current from said generator to the electrical storage means through the electronic control device.

Various aspects and embodiments of a system and a method for recharging electric and hybrid vehicle batteries according to the invention have been described. It is intended that each embodiment may be combined with any other embodiment. Furthermore, the invention is not limited to the embodiments described, but may be modified within the scope defined by the attached claims.

1. A system for recharging batteries of electric and hybrid vehicles by recovering and converting kinetic energy produced by rotational movement of wheels into electric current, said system comprising:
a tire-carrying rim configured to support a tire;
an electric current generator comprising a rotor, integrated in an inner surface of said tire-carrying rim, and a circular-shaped stator rotationally fixed with respect to the tire-carrying rim and configured to be anchored to a fixed part of a wheel-carrying hub, in a volume between a brake mechanically connected to said wheel-carrying hub, and the inner surface of the tire-carrying rim;
batteries electrically connected to the electric current generator, said batteries being suppliable by current produced by said electric current generator; and
an electronic control device, electrically connected to the batteries and suppliable by the current produced by the electric current generator; wherein said electronic control device is configured to allow passage of a flow of current exclusively from said electric current generator to the batteries.

2. The system of claim 1, wherein the electronic control device is configured to adjust voltage and intensity of said flow of current from said electric current generator to the batteries.

3. The system of claim 1, further comprising permanent magnets fixed to the inner surface of the tire-carrying rim by a polyurethane resin.

4. The system claim 1, wherein the circular-shaped stator is made of a polyurethane resin having a solid end state and contains enameled copper wire.

5. The system of claim 1, further comprising a wheel-carrying hub that rotatably supports the tire-carrying rim, and a brake mechanically connected to the wheel-carrying hub and configured to impart a brake torque on the tire-carrying rim.

6. A method for recharging batteries of electric and hybrid vehicles, said method comprising the steps of:
(a) providing a system comprising:
a tire-carrying rim configured to support a tire;
an electric current generator comprising a rotor integrated in an inner surface of said tire-carrying rim, and a circular-shaped stator rotationally fixed with respect to the tire-carrying rim and configured to be anchored to a fixed part of a wheel-carrying hub, in a volume between a brake mechanically connected to said wheel-carrying hub, and the inner surface of the tire-carrying rim;
batteries electrically connected to the electric current generator, said batteries being suppliable by current produced by said electric current generator; and
an electronic control device electrically connected to the batteries and suppliable by the current produced by the electric current generator; wherein said electronic control device is configured to allow passage of a flow of current exclusively from said electric current generator to the batteries;
(b) providing a vehicle having at least one wheel to which the system of step (a) is associated; and
(c) transmitting the current produced by the electric current generator from the circular-shaped stator to the batteries by the electronic control device when the vehicle is travelling.

7. The method of claim 6, wherein step (c) is carried out by adjusting voltage and intensity of said flow of current from said electric current generator to the batteries through the electronic control device.
